(19) United States
(12) Patent Application Publication
(10) Pub. No.: US 2002/0091843 A1
(43) Pub. Date: Jul. 11, 2002

(54) Wireless network adapter

(76) Inventor: Rahul R. Vaid, New York, NY (US)

Correspondence Address: FOLEY, HOAG & ELIOT, LLP, PATENT GROUP, ONE POST OFFICE SQUARE, BOSTON, MA, 02109, US

(21) Appl. No.: 09/746,484

(22) Filed: Dec. 21, 2000

Related U.S. Application Data
(60) Provisional application No. 60/172,904, filed on Dec. 21, 1999.

(51) Int. Cl. G06F 15/16

(52) U.S. Cl. 709/230; 709/250

(57) ABSTRACT

A system according to the principles of the invention includes an adapter that aggregates network traffic from a plurality of Portable Computing Devices and combines the aggregated data into a wireless network data channel. The adapter may include a wireless network interface for establishing and maintaining a wireless network channel with a wireless base station, and may combine the data in a manner that preserves addressing information (such as IP source and destination addresses) for each individual PCD. A wireless Internet service provider may separate the data according to a predetermined protocol, and create individual data packets, such as IP packets, for each PCD using the network data channel. A complementary operation may be performed for data received at the wireless base station and addressed to PCD's connected to the adapter. In this manner, a number of PCD's may be in bi-directional communication with a network using a single data channel.

### CROSS REFERENCE TO RELATED APPLICATIONS

This application is based upon, claims the benefit of, and incorporates by reference the entire disclosure of U.S. Provisional Patent Application No. 60/172,904, filed on Dec. 21, 1999.

### FIELD OF INVENTION

The invention relates generally to the field of wireless access to data networks, and more particularly to a wearable Internet adapter for sharing a wireless data channel among a number of portable computing devices.

### BACKGROUND

The personal computer revolution has enhanced productivity through the use of static computing devices. With the advent of the data networking, and in particular the Internet and the World Wide Web, these static devices have been connected to a variety of resources for information, services, and commerce. More recently, smaller and faster notebook computers have improved user mobility and increased demand for ubiquitous data network access. Handheld computing devices, like Personal Digital Assistants and Palm Top computers, and low cost network-connectable appliances, like kitchen-top and closet computer devices, are also gaining popularity in the market. As a result, people (and their devices) increasingly seek to connect to data networks such as the Internet to conduct their day-to-day business and avail themselves of the resources of the Web.

While network access for existing mobile computers is being commercialized on a widespread scale through wireless and wired network connectivity, even smaller and faster computers in body wearable shapes and forms are emerging. Wearable computing refers to computers that may be worn, much as eyeglasses or clothing are worn, and that interact with a user based on the context of the situation. With heads-up displays, unobtrusive input devices, personal wireless local area networks, and a host of other context sensing and communication tools, a wearable computer can act as an intelligent personal device.

With the increasing popularity of smaller and faster computers in the form of mobile computers, portable computers, handheld computing devices, low cost network connectable appliances, and wearable computers (collectively “Portable Computing Devices” or “PCD's”), people may soon be carrying two or more PCD's at one time. Each PCD may require significant bandwidth overhead for wireless channel setup, take down, and communication, even where only small amounts of data payload are to be transmitted. Cellular or other wireless networks designed for voice traffic are particularly prone to wasting bandwidth since each channel is dedicated to a full voice band. Furthermore, some promising PCD's employ near-constant network connectivity. As more PCD's provide near-constant connectivity, the wasted bandwidth, both in traffic management overhead and unused data capacity, increases.

There remains a need for a device that adapts the data networking demands of numerous small-bandwidth devices to the fixed-bandwidth traffic channels of typical wireless systems.

### SUMMARY OF INVENTION

A system according to the principles of the invention includes an adapter that aggregates network traffic from a plurality of Portable Computing Devices and combines the aggregated data into a wireless network data channel. The adapter may include a wireless network interface for establishing and maintaining a wireless network channel with a wireless base station, and may combine the data in a manner that preserves addressing information (such as IP source and destination addresses) for each individual PCD. A wireless Internet service provider may separate the data according to a predetermined protocol, and create individual data packets, such as IP packets, for each PCD using the network data channel. A complementary operation may be performed for data received at the wireless base station and addressed to PCD's connected to the adapter. In this manner, a number of PCD's may be in bi-directional communication with a network using a single data channel.

### BRIEF DESCRIPTION OF DRAWINGS

The foregoing and other objects and advantages of the invention will be appreciated more fully from the following further description thereof, with reference to the accompanying drawings, wherein:

FIG. 1 shows a block diagram of a system using a wireless network adapter for portable computing devices;

FIG. 2 shows a plurality of wearable computing devices sharing an adapter;

FIG. 3 shows a block diagram of a wireless network adapter for portable computing devices;

FIG. 4 shows a block diagram of a terminal port cluster;

FIG. 5 shows a block diagram of a port processing unit;

FIG. 6 shows a block diagram of a shared signal processing unit;

FIG. 7 shows a block diagram of an intelligent services unit;

FIG. 8 shows a network communications unit;

FIG. 9 shows data flow in a system using a wireless network adapter; and

FIGS. 10A-10H show a flow chart of a process using a wireless network adapter.

### DETAILED DESCRIPTION OF THE PREFERRED EMBODIMENT(S)

To provide an overall understanding of the invention, certain illustrative embodiments will now be described, including a wearable wireless network adapter. However, it will be understood by those of ordinary skill in the art that the methods and systems described herein can be suitably adapted to any environment where numerous low data-rate channels can be advantageously combined into a wireless network channel.

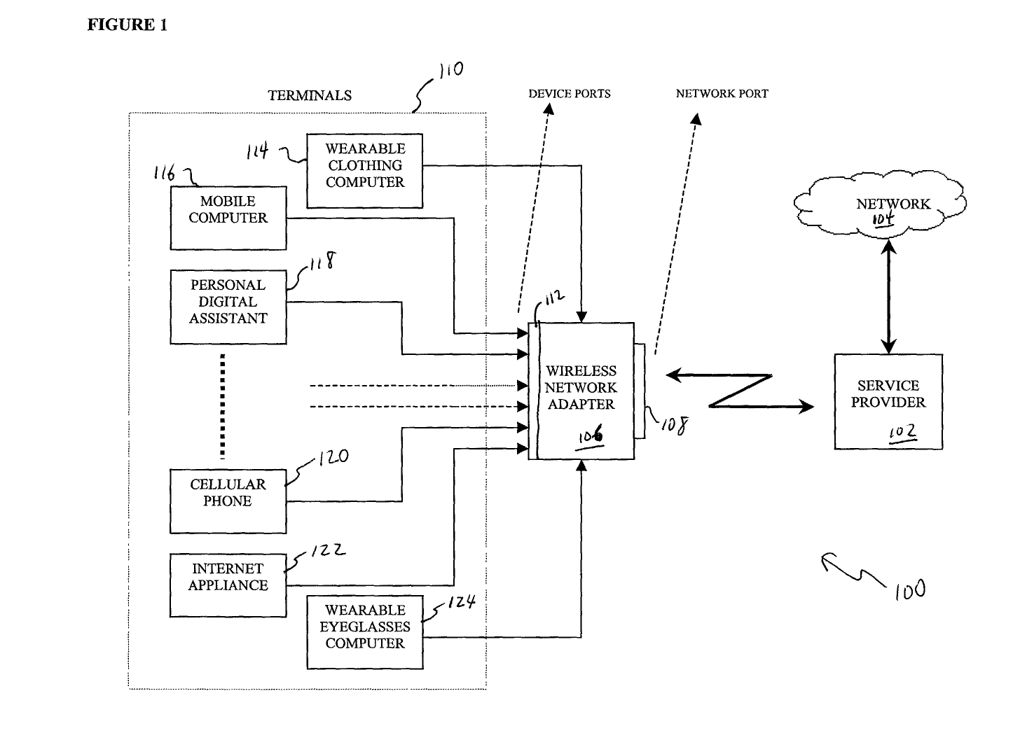

FIG. 1 shows a block diagram of a system using a wireless network adapter for portable computing devices. The system 100 may include a service provider 102 connected in a communicating relationship with a network 104 and a wireless network adapter 106. The wireless network adapter (“WNA”) 106 may communicate with the service provider 102 through a network port 108, and may communicate with a plurality of terminals 110 through a plurality of device ports 112.

The terminals 110 may include, for example, a wearable clothing computer 114, a mobile computer 116 such as a laptop or notebook computer, a personal digital assistant 118, a cellular phone 120, an Internet appliance 122, or a wearable eyeglass computer 124, as well as other devices not depicted, including a two-way pager, wristwatch phone, mobile screen, Web pad, personal communicator, Wireless Access Protocol (“WAP”) enabled phone or other device, and so forth. Each of these terminals 110 may have an input/output port that may use a standard or proprietary data format and protocol suitable for a twisted-wire pair connection, serial or parallel connection, other wired connection, short-range wireless connection, or other connection suitable to wearable and portable devices. The terminals 110 may include devices using a number of different platforms including Windows, Unix, Linux, Wireless Access Protocol and/or Wireless Markup Language, Palm OS, Windows CE, Windows ME, and so forth. The terminals 110 may communicate data of different types including voice, audio, video, or general data in any form including Internet Protocol and Universal Datagram Protocol packets, Asynchronous Transfer Mode and/or Frame Relay cells, SONet payloads, Synchronous Data Hierarchy, and so forth.

The wireless network adapter 106 may be body wearable or portable, or the WNA 106 may be an attachment or docking device adapted for mechanical and electrical attachment to a terminal 110. The WNA 106 may also be installed in, or connected to, a fixed wireless base station. The device ports 112 of the WNA 106 may be adapted to the connections of the terminals 110, with each terminal 110 connected in a communicating relationship with one of the device ports 112 of the WNA 106. The device ports 112 may support a number of different data and communication standards, including, for example, HomeRF, IEEE 802.11, Bluetooth, RS-232, RS-422, RS-520, IrDA, Universal Serial Bus (“USB”), and S-Video. The network port 108 may communicate with the service provider 102 using a cellular phone standard based upon Code Division Multiple Access (“CDMA”), Time Division Multiple Access (“TDMA”), Frequency Division Multiple Access (“FDMA”), or some combination of these, including current cellular telephony standards and emerging third generation standards. The service provider 102 may also communicate with the WNA 106 using wireless local loop services, or any other wireless communication standard capable of providing connections to a data network such as the Internet.

The device ports 112 may be physically packaged into removable and replaceable modules. Each module may include a port physically adapted to a particular wireless or wired connection type, e.g., USB, Bluetooth, etc. Each module may include a WNA connector which presents a uniform attachment to the WNA independent of the port type. In this embodiment, a user may obtain a WNA 106 having a number of slots for ports. One or more device ports 112 may then be inserted into the slots according to the needs of the user. For example, if a user has two Bluetooth devices and one RS-232 device, then the user may obtain two Bluetooth device ports 112 and one RS-232 device port 112, and insert these modular device ports into available slots of the WNA 106. Blank ports may also be provided to fill unused slots of a WNA 106, and to protect electrical contacts and the structure of an unused slot from damage and wear.

The device ports 112 and the WNA 106 may convert signals generally between different voltage/current levels, different physical connector types, different data formats, different data protocols, and different data rates.

The network 104 may be any network for communicating data, including, for example, the Internet. The structure of the Internet 110 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the network 104. For a more detailed description of the structure and operation of an Internet embodiment of the network 104, one may refer to “The Internet Complete Reference,” by Harley Hahn and Rick Stout, published by McGraw-Hill, 1994, the teachings of which are incorporated herein by reference. However, one may practice the present invention on a wide variety of communication networks, either private or public, other than the Internet, or in combination with the Internet. For example, the network 104 may include interactive television networks, telephone networks including the Public Switched Telephone Network, wireless data transmission systems including wireless local loop systems, two-way cable systems, customized computer networks, interactive kiosk networks and automatic teller machine networks.

In its deployment as the Internet, the network 104 consists of a worldwide computer network that communicates using the well-defined Transmission Control Protocol (“TCP”) and Internet Protocol (“IP”) to provide transport and network services. Computer systems that are directly connected to the network 104 may each have a unique IP address. The IP address consists of four one-byte numbers (although a planned expansion to sixteen bytes is underway with IPv6). The four bytes of the IP address are commonly written out separated by periods such as “209.216.207.140”. To simplify Internet addressing, the Domain Name System (“DNS”) was created. The DNS allows users to access Internet resources with a simpler alphanumeric naming system. A DNS name consists of a series of alphanumeric names separated by periods. When a domain name is used, the computer accesses a DNS server to obtain the explicit four-byte IP address. Other schemes may be used, such as Asynchronous Transfer Mode (“ATM”) communications, Frame Relay, SONet, or SDH over private networks, or over Virtual Private Networks (“VPNs”) maintained on public networks. It will be appreciated that some of the above networks may be combined, such as with IP-over-SONet or IP-over-ATM.

The service provider 102 may be any service provider capable of providing wireless access to the network 104. The service provider 102 may establish connections to the network 104 using, for example, X.25/Frame Relay networks, Integrated Subscriber Digital Network lines, Digital Subscriber Lines, either symmetric or asymmetric, Asynchronous Transfer Mode connections, a Local Area Network connection, a Wide-Area Network connection, a Metropolitan Area Network connection, a fiber optic network connection based upon, for example Synchronous Optical Networking, and so forth.

The service provider 102 may charge for a wireless connection to the network 104 as described herein. This service charge may be, for example, greater than a charge for a single wireless network connection, but less than a charge for a number of wireless network connections, as would otherwise be required for a plurality of devices, each having its own network connection. There is accordingly provided herein a method of doing business that includes charging a customer for a multi-device connection to a network. In this method, the service provider 102 may provide the WNA 108 at no charge to a user who subscribes to the wireless service. The cost to the service provider 102 may then be recovered through the premium charged for multi-device wireless service. Internet service providers may also realize overall savings since they may economize their usage of increasingly crowded radio frequency traffic channels.

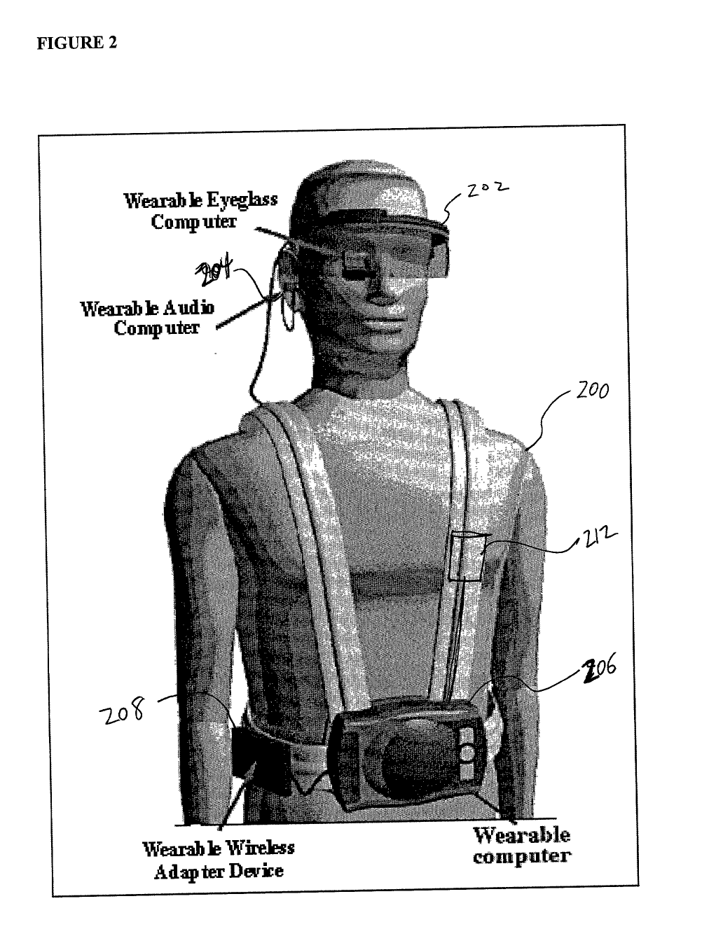

FIG. 2 shows a plurality of wearable computing devices sharing an adapter. A user 200 may wear or carry a number of devices, including a wearable eyeglass computer 202, a wearable audio computer 204, or a wearable computer 206. These devices may be connected to a WNA 208. Each of these devices may be a separate computing device, or may operate together as a single, wearable computer to provide audio output, visual output, and processing power for the user 200. Input may be through the wearable computer, or through additional devices such as a retina tracking device or a handheld device within one of the devices.

Other devices that may be connected to the WNA include a cellular phone, WAP-enabled device, personal digital assistant, laptop computer, notebook computer, wristwatch computer, and so forth. Devices may be any devices adapted to be worn or carried by the user 200, and may generally include any device that includes a processor or other processing device, along with a network or data port for communicating with external devices. Devices may have integral power supplies, such as batteries, or may obtain power from a central power supply such as a battery pack. Connections between the devices 202, 204, 206 and the WNA 208 may be through wires 210, or may be through a wireless, short-range connection such as BlueTooth. The WNA 208 generally establishes communications between the devices and the network 104 of FIG. 1.

In one embodiment a wireless communication device 212, such as a cellular phone, personal digital assistant with wireless network capability, or other device may establish a connection to the network 104 of FIG. 1, and data sent and received over this connection may be coupled to the WNA 208. The WNA 208 may share this connection among other devices as described in more detail below.

In one embodiment a plurality of wireless communication devices (“PCDs”) 212 with or without wireless network capability, may simultaneously establish connections to the network 104 of FIG. 1, and data sent and received and sent over this connection may be combined using statistical techniques such as those described below. The PCDs 212 may include cellular phones, personal digital assistants, or other devices.

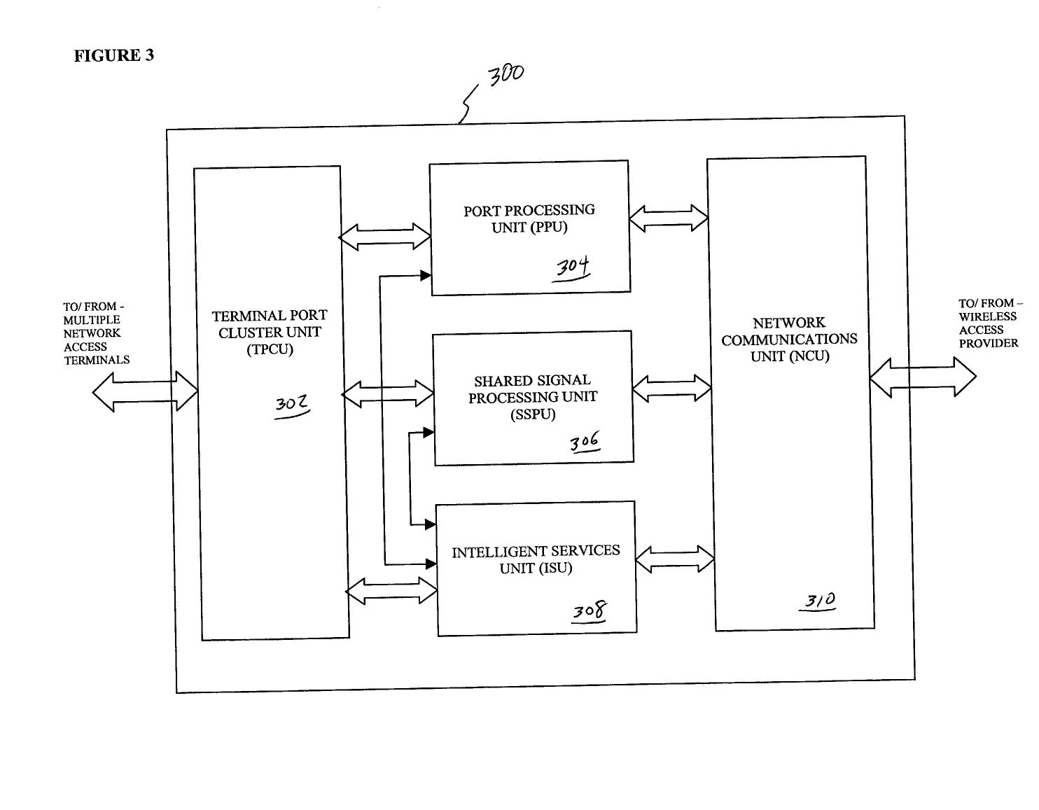

FIG. 3 shows a block diagram of a wireless network adapter for portable computing devices. A wireless network adapter 300 may include a terminal port cluster unit 302, a port processing unit 304, a shared signal processing unit 306, an intelligent services unit 308, and a network communications unit 310. In general, the terminal port cluster unit 302 may establish connections to devices used by the user 200 of FIG. 2. The port processing unit 304 may coordinate operation of the network communications unit 310. The shared signal processing unit 306 may process signals so that they may be communicated between the terminal port cluster unit 302 and the network communications unit 310. The intelligent services unit 308 may provide additional services to optimize usage of network connections. The network communications unit 310 maintains one or more connections to a network, such as the network 104 of FIG. 1, under control of the port processing unit 304, the shared signal processing unit 306, and the intelligent services unit 308. As may be clear from the description to follow, the wireless network adapter 300 may not include the port processing unit 304, or may not include the shared signal processing unit 306, if not suitable for an air interface used by the network communications unit 310.

It will be appreciated that each of the components of the WNA 300 described above may be realized in different forms. This may include, for example, one or more processors, microcontrollers, programmable digital signal processors, or other devices programmed to perform the functions thereof using software or firmware. The components may also be realized in dedicated devices such as application specific integrated circuits, programmable array logic, programmable logic devices, and so forth. Functionality may also be realized using discrete analog and/or digital components. The components may also include any combination of the above forms, provided that the system has sufficient processing power to meet data rate requirements of ports used by the WNA.

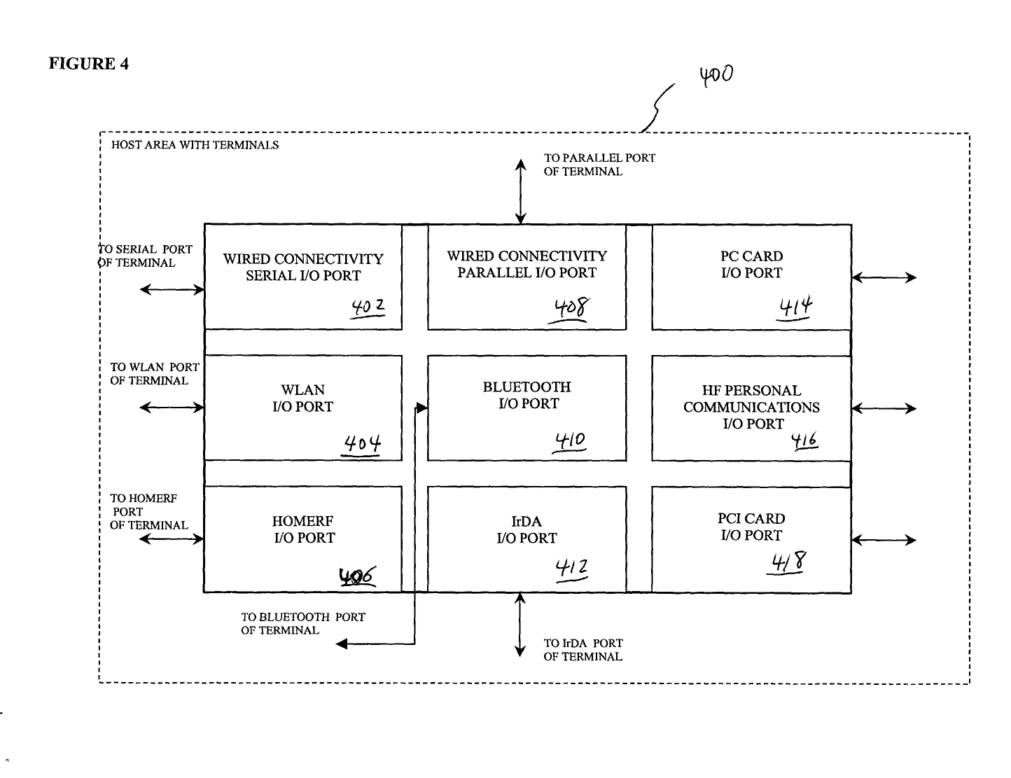

FIG. 4 shows a block diagram of a terminal port cluster. A terminal port cluster 400 may be the terminal port cluster 302 of FIG. 3. The terminal port cluster 400 may include a plurality of ports for data transmission using different standards and protocols, including a serial input/output port 402 for wired connectivity, a wireless local area network input/output port 404, a HomeRF input/output port 406, a parallel input/output port 408 for wired connectivity, a BlueTooth input/output port 410, an IrDA input/output port 412, a personal computer card input/output port 414 for use with a network interface card of a computer, a high-frequency personal communications input/output port 416, and a Peripheral Component Interconnect (“PCI”) card input/output port 418 for connection to, for example, a PCI network card. In the following discussion, the use of “input/output” with reference to bi-directional ports may be omitted.

Although not shown, other ports may include an Ethernet port, a Universal Serial Bus port, an RS-232 port (which may be, for example, the serial port 402), or a Firewire port. Each of the above port types is known, and may be suitably used with the systems described herein to establish connections with one or more devices used by a user, such as the user 200 of FIG. 2. It will be appreciated that the terminal port cluster 400 may include more than one of any or all of the above ports. It will further be appreciated that any other port may be used with the invention provided the port operates according to a predetermined communication standard. Each port type may have a different data rate, and a different data format. As such, the components described below may be used to conform data communicated through these ports to the network port 108 of the WNA 106 of FIG. 1, as well as to maintain an association, at the service provider 102, between data and a terminal device connected to one of the ports.

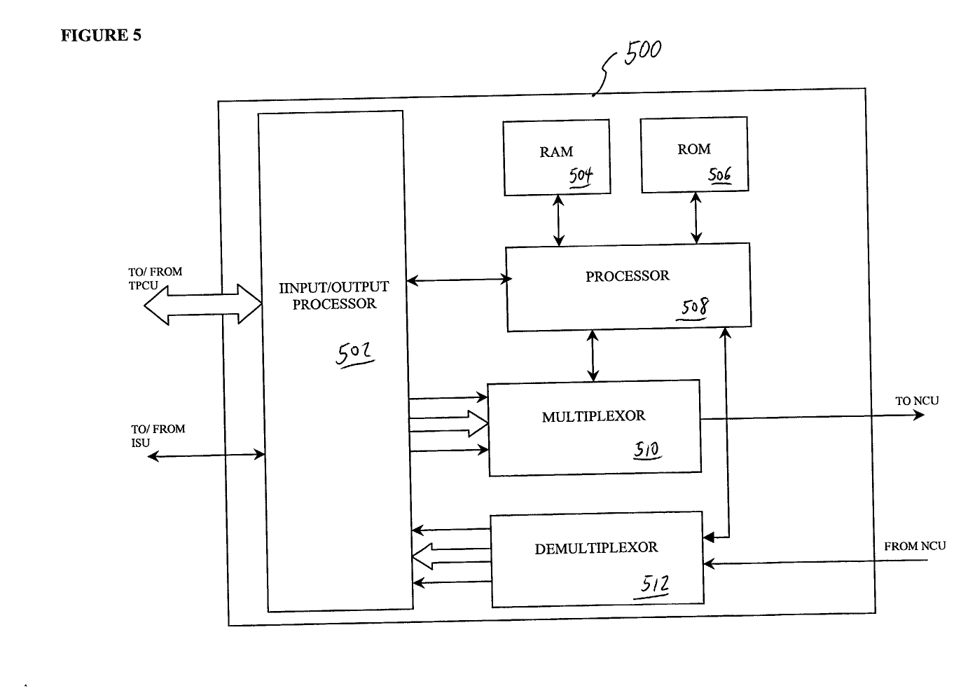

FIG. 5 shows a block diagram of a port processing unit. The port processing unit 500 may be the port processing unit 304 of FIG. 3. The port processing unit 500 may include an input/output processor 502, a random access memory 504, a read-only memory 506, a processor 508, a multiplexor 510, and a demultiplexor 512. The input/output processor 502 establishes connections with the ports of the terminal port cluster unit 302 of FIG. 3, as indicated by a bi-directional arrow 514 that represents a bus or other connection to the terminal port cluster 302. The input/output processor 502 may also communicate with the intelligent services unit 308, which may provide control information for operation of the port processing unit 500. The multiplexor 510 receives data from a number of devices received through the input/output processor 502, and multiplexes the data into a data stream. The demultiplexor 512 receives a data stream from the network communications unit 310 of FIG. 3, and separates the data stream into data for devices using the port processing unit 500. The processor 508 may control operation of the input/output processor 502, the multiplexor 510, and the demultiplexor 512.

In general, the port processing unit 500 may multiplex data streams into a signal that may be used with a multiple-access air interface by the network communications unit 310 of FIG. 3. That is, where a particular number of devices are sharing a connection, and the air interface can accommodate that particular number of logic channels in a single physical layer connection (e.g., a frequency divided into logical channels using, for example, time-division multiple access, code division multiple access, orthogonal frequency division multiplexing, or other statistical or frequency multiple access techniques), then each device may be mapped to a logical channel of the air interface and the devices may simultaneously communicate data through the connection.

It will be appreciated that this mapping may be implied, as where the service provider 102 assumes that each logical channel corresponds to a separate device, or explicit, as where the signal for each logical channel has embedded therein an identifier of a device using the logical channel. The service provider 102 may assign a separate IP address, or other network address, session identifier, or user identifier, to each device so that separate connections to the network 104 may be maintained for each device so connected. Data from the WNA 106 may then be placed into packets (or other network formats) bearing a source address corresponding to the device using the logical channel. Data from the network 104 may be examined to determine an IP destination address, and this information may be used to map the data to a logical channel corresponding to the device using the IP address. There is accordingly provided a network gateway for mapping devices that share a wireless connection to a plurality of IP addresses, each IP address corresponding to a device, according to the techniques described herein.

Where the air interface used to communicate data between the network communication unit 310 and the service provider 102 can not accommodate the number of devices sharing a channel, the shared signal processing unit 306 of FIG. 3 may be used, as will be described below.

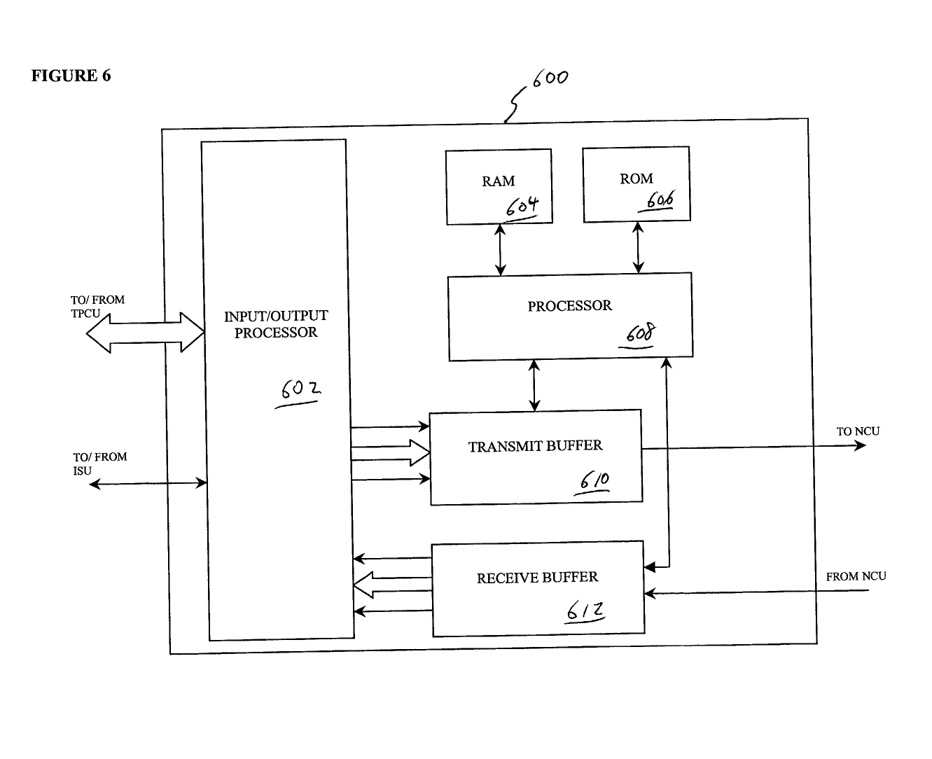

FIG. 6 shows a block diagram of a shared signal processing unit. A shared signal processing unit 600 may include an input/output processor 602, a random access memory 604, a read-only memory 606, a processor 608, a transmit buffer 610, and a receive buffer 612. The input/output processor 602 establishes connections with the ports of the terminal port cluster unit 302 of FIG. 3, as indicated by a bi-directional arrow 614 that represents a bus or other connection to the terminal port cluster 302. The input/output processor 602 may also communicate with the intelligent services unit 308, which may provide control information for operation of the shared signal processing unit 600. The transmit buffer 610 receives data from a number of devices received through the input/output processor 602, and buffers the data for communication to the network communications unit 310 as a single data stream. The receive buffer 612 receives a data stream from the network communications unit 310 of FIG. 3, and separates the data stream into data for devices using the shared signal processing unit 600. The processor 608 may control operation of the input/output processor 602, the transmit buffer 610, and the receive buffer 612.

In general, the shared signal processing unit 600 may arbitrate communications between the input/output processor 602 and a number of devices attached thereto. Where end-to-end connectivity is desired for devices, for example, the shared signal processing unit 600 may lock access to the buffer for a current device, subject to prioritization as discussed below. In this manner, devices may obtain dedicated access to a wireless connection maintained by the network communications unit 310 for some time-limited, priority sensitive, or otherwise predetermined duration, during which bi-directional communications may be maintained between the device and the network 104. Devices connected to the WNA may share access to the WNA using a carrier-sense protocol, a token-ring, token-bus, polling, broadcast, time-slot based, or other protocol. In one embodiment, the shared signal processing unit 600 may receive access requests from terminals and respond to access requests according to a predetermined prioritization scheme for terminals. In one embodiment, the shared signal processing unit 600 may poll terminals and grant access to a terminal according to response received from one or more devices to the poll. Polling may be broadcast to all terminals, or addressed to terminals in a predetermined order according to, for example, a priority associated with each terminal.

The shared signal processing unit 600 may be used to maintain network data connections for a number of devices using a single logical channel of an air interface maintained by the network communications unit 310 of FIG. 3. The transmit buffer 610 may provide a single output data stream for transmission over the air interface, with the single output data stream mapped to a number of different devices. It will be appreciated that this mapping may be implied, as where the service provider 102 assumes that each consecutive frame, packet, word, or number of bits corresponds to a separate device, or the mapping may be explicit, as where the signal for each device is identified within the channel by a header, preamble, or other identifier. The service provider 102 may arbitrate use of an IP address by a number of devices. The shared signal processing unit 600 may track use of the shared connection by the devices. The service provider 102 may also assign a separate IP address to each device so that separate connections to the network 104 may be maintained. Data from the WNA 106 may then be placed into IP packets bearing a source address corresponding to a particular device. Data from the network 104 may be examined to determine an IP destination address, and this information may be used to map the data to a field, identifier, or other explicit or implicit identifier corresponding to the device using the IP address. There is accordingly provided a network gateway for mapping devices that share a wireless connection to a plurality of IP addresses, each IP address corresponding to a device, according to the techniques described herein.

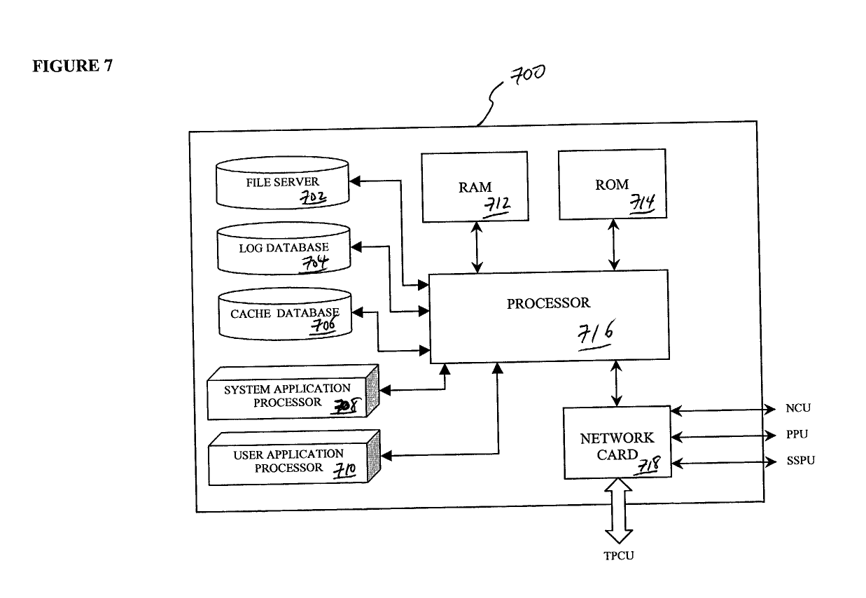

FIG. 7 shows a block diagram of an intelligent services unit. An intelligent services unit 700 may include a file server database 702, a log database 704, a cache database 706, a system application processor 708, a user application processor 710, a random access memory 712, a read-only memory 714, a processor 716, and a network card 718. As may appear from the following, the system application processor 708, the user application processor 710, and the processor 716 may be separate processors, or may be separate processes running on a single processing device. The intelligent services unit 700 may generally provide network services associated with a personal area network maintained by the wireless network adapter 300 of FIG. 3. These network services may include, for example, device connectivity, error detection and correction, load balancing, caching, traffic management, congestion control, and other services related to network performance. The network services may also include enhanced services such as file sharing, printer sharing, distributed computing, and so forth.

The file server database 702 may store information relating to files and other data distributed throughout a personal area network maintained by the wireless network adapter 300 of FIG. 3. The file server database 702 may be used to track locations of files, access to files, access rights of files, and capabilities of devices storing files. The log database 704 may be used to store transactions, usage, and other data for statistical analysis, transaction roll-back, and any other functions that may be performed using a log file. The cache database 706 may store frequently accessed data, from devices connected to the wireless network adapter 300 of FIG. 3, as well as from the network 104 of FIG. 1, to reduce network usage related to transferring data multiple times.

Using the file server database 702, local data within the personal area network may be transparently shared among devices. For example, a cellular phone may access contact information, such as names, phone numbers, e-mail addresses, and the like, stored in a personal digital assistant. Other data transfers may be realized, such as a watch providing time information to a PDA, a cellular phone playing audio data received by a web-enabled PDA, and so forth. Distributed computing may be realized through the file server database 702. Executable code may be communicated among processors of a number of devices, and results may be collected and further processed by the intelligent services unit, or a device within the personal area network.

The system application processor 708 may provide processing associated with the functions described above. The user application processor 710 may provide additional functionality as may be specified by a user of the wireless network adapter 300 of FIG. 3. The processor 716 may provide overall control of the intelligent service unit 700, and may also provide overall control of the wireless network adapter 300 of FIG. 3 by communicating with the network communications unit 310, the port processing unit 304, the shared signal processing unit 306, and the terminal port cluster unit 302 of FIG. 3, through a network card 718.

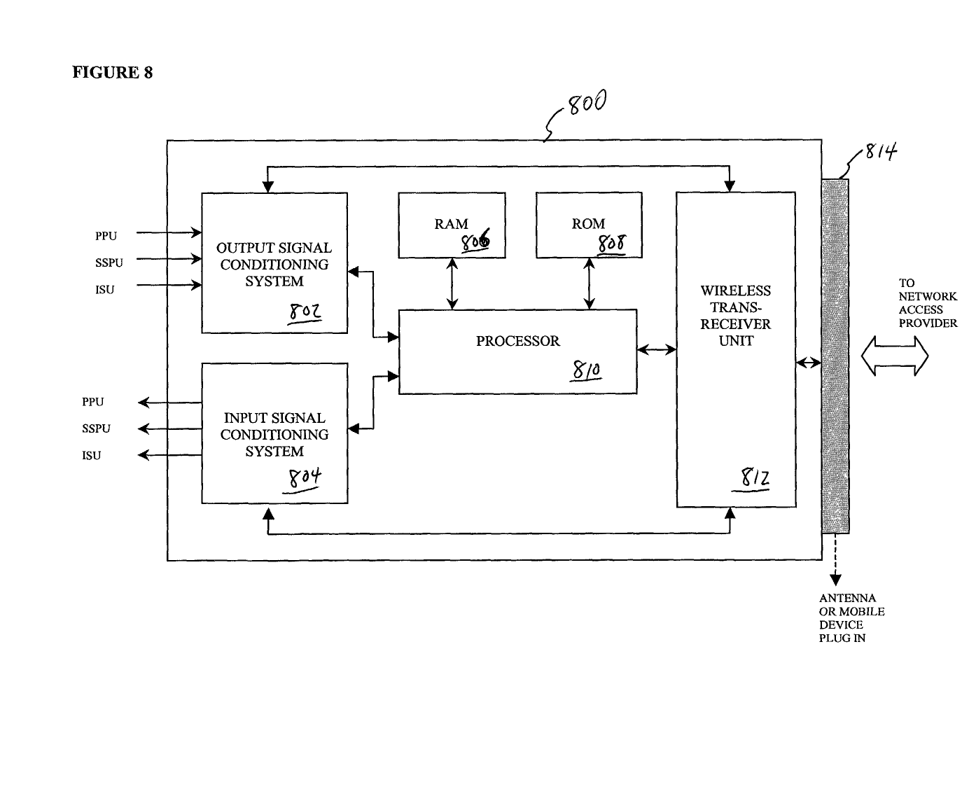

FIG. 8 shows a network communications unit. A network communications unit 800 may include an output signal conditioning system 802, an input signal conditioning system 804, a random access memory 806, a read-only memory 808, a processor 810, and a wireless transceiver unit 812. The output signal conditioning system 802 may receive signals from the port processing unit 500, the shared signal processing unit 600, and the intelligent services unit 700, and convert the received signals into a form suitable for transmission by the wireless transceiver unit 812. The input signal conditioning system 804 may receive signals from the wireless transceiver unit 812 and convert the signals into a form suitable for transmission to the port processing unit 500, the shared signal processing unit 600, or the intelligent services unit 700. The processor 810 may control operation of the output signal conditioning system 802, and in particular, which of the port processing unit 500, the shared signal processing unit 600, and the intelligent services unit 700 is currently selected for transfer of data to the wireless transceiver unit 812. The processor 810 may also control operation of the input signal conditioning system 804, and in particular, which of the port processing unit 500, the shared signal processing unit 600, or the intelligent services unit 700 receives data from the wireless transceiver unit 812. The process 810 may perform the above-described switching functions autonomously, or under control of the intelligent services unit 700. The wireless transceiver unit 812 may include circuitry 814 for coupling to a wireless air interface. The wireless transceiver unit 812 may alternatively, or in addition, include circuitry 814 for a wired connection to a separate wireless transceiver, which may be, for example, a cellular phone or other device with a wireless port.

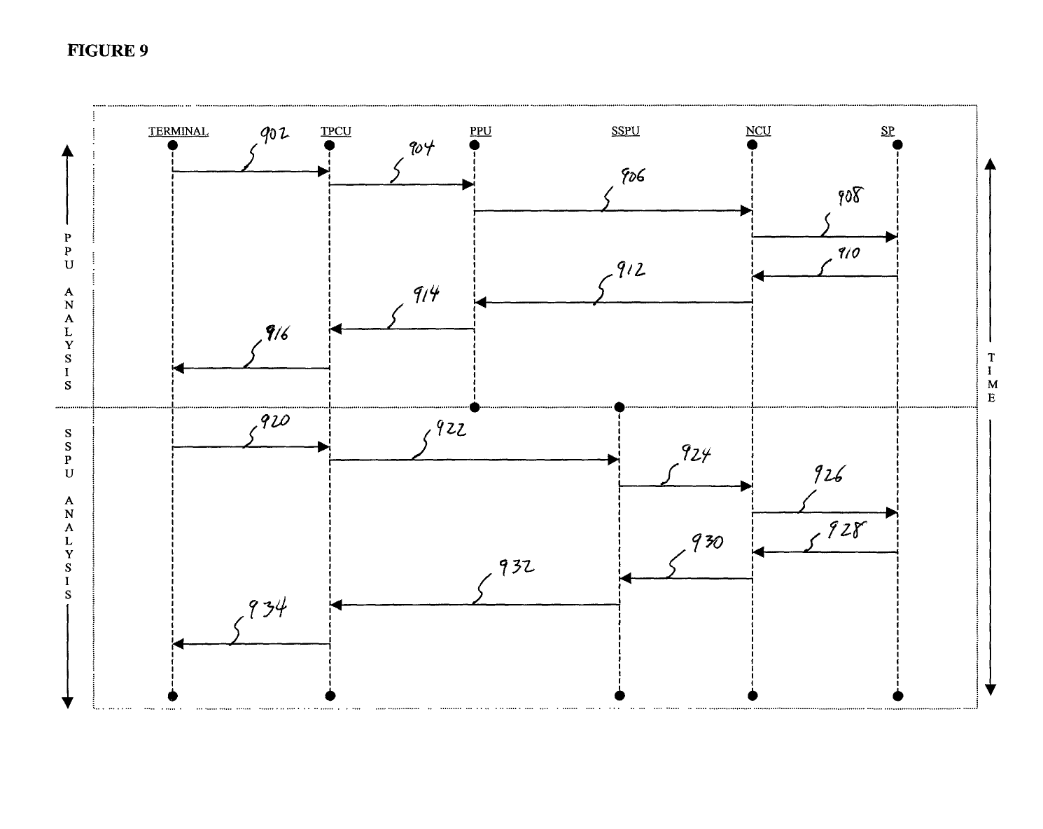

FIG. 9 shows data flow in a system using a wireless network adapter. A terminal, such as any of the devices described above that may be used with a wireless network adapter, originates outgoing data to a terminal port cluster unit, as shown by a first data transfer 902. As described above, it may be determined whether the data is to be transmitted using a port processing unit or a shared signal processing unit. Where the data is to be transmitted using the port processing unit, the data is transferred to the port processing unit as shown by a second data transfer 904. The port processing unit may convert the data into a form suitable for wireless transmission, and may label the data with an identifier that signifies the originating terminal. The data may then be transferred to a network communications unit as shown by a third data transfer 906. The data may then be transmitted over a wireless connection to a service provider as shown by a fourth data transfer 908. The service provider may then associate the data with a particular IP address, as described above, or some other address or source designation information suitable for a network used by the service provider.

The service provider may receive a return message or an original message including data and addressed to the terminal. The data may be transferred over the wireless connection to the network communications unit, as shown by a fifth data transfer 910. The network communications unit may process the data to determine a destination terminal. The data may be converted to a form suitable for transmission within the personal area network maintained by the wireless network adapter, and forwarded to an appropriate processing unit, in this case the port processing unit, as shown by a sixth data transfer 912. The port processing unit may forward the data to the terminal port cluster unit as shown by a seventh data transfer 914. The terminal port cluster unit may convert the data into a form suitable for a particular one of the ports of the terminal port cluster unit, and may transfer the data to the terminal through a suitable port, as shown by an eighth transfer 916.

In another example, a terminal, such as any of the devices described above that may be used with a wireless network adapter, originates outgoing data to a terminal port cluster unit, as shown by a first data transfer 920. As described above, it may be determined whether the data is to be transmitted using a port processing unit or a shared signal processing unit. Where the data is to be transmitted using the shared signal processing unit, the data is transferred to the shared signal processing unit as shown by a second data transfer 922. The shared signal processing unit may convert the data into a form suitable for wireless transmission, and may label the data with an identifier that signifies the originating terminal. The data may then be transferred to a network communications unit as shown by a third data transfer 924. The data may then be transmitted over a wireless connection to a service provider as shown by a fourth data transfer 926. The service provider may then associate the data with a particular IP address, as described above, or some other address or source designation information suitable for a network used by the service provider.

The service provider may receive a return message or an original message including data and addressed to the terminal. The data may be transferred over the wireless connection to the network communications unit, as shown by a fifth data transfer 928. The network communications unit may process the data to determine a destination terminal. The data may be converted to a form suitable for transmission within the personal area network maintained by the wireless network adapter, and forwarded to an appropriate processing unit, in this case the shared signal processing unit, as shown by a sixth data transfer 930. The shared signal processing unit may forward the data to the terminal port cluster unit as shown by a seventh data transfer 932. The terminal port cluster unit may convert the data into a form suitable for transfer over a particular one of the ports of the terminal port cluster unit, and may transfer the data to the terminal through a suitable port, as shown by an eighth transfer 934.

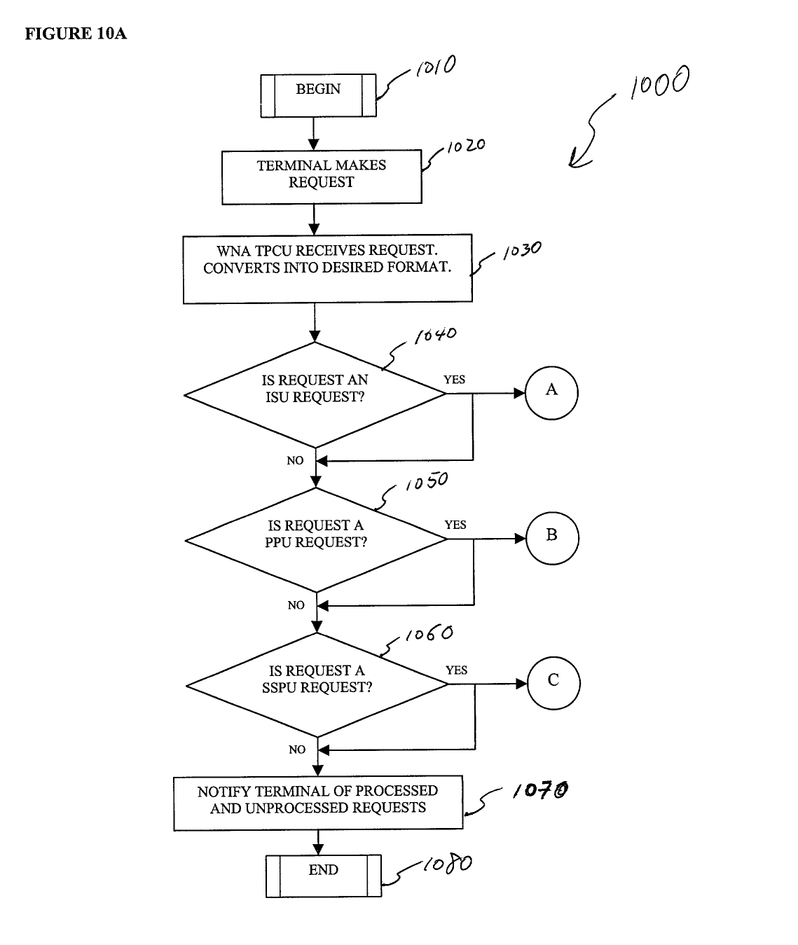

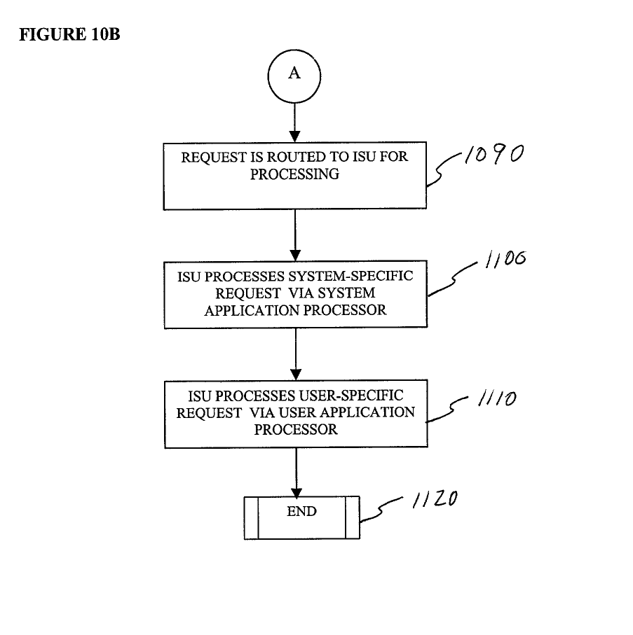

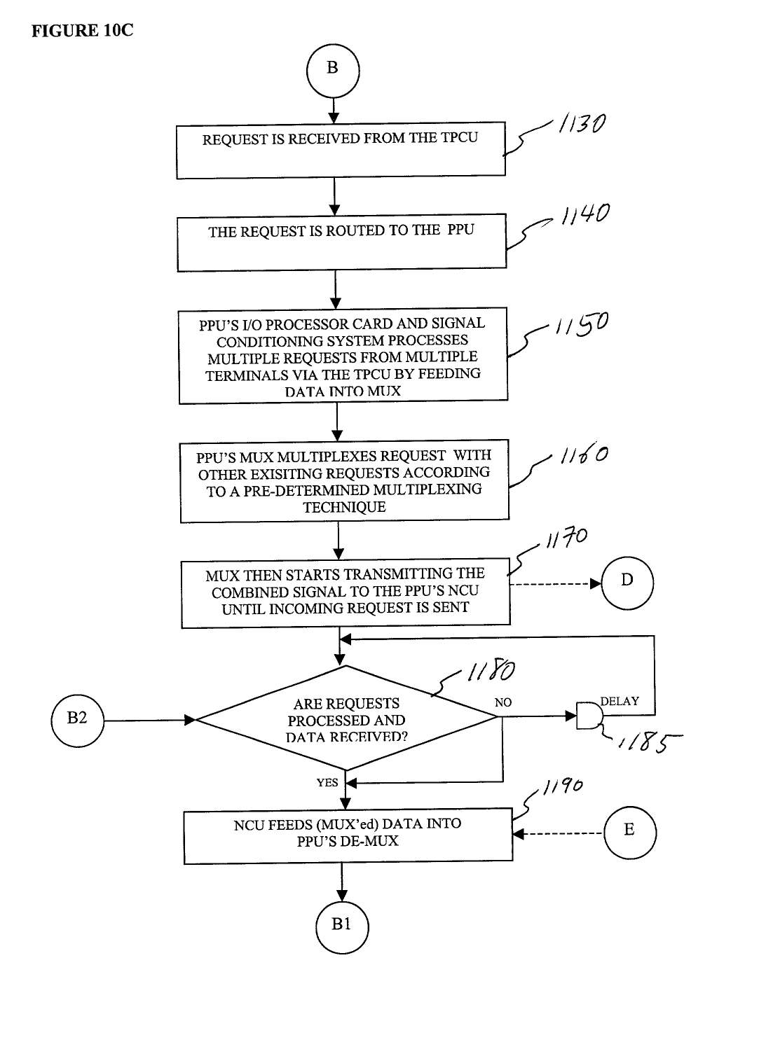

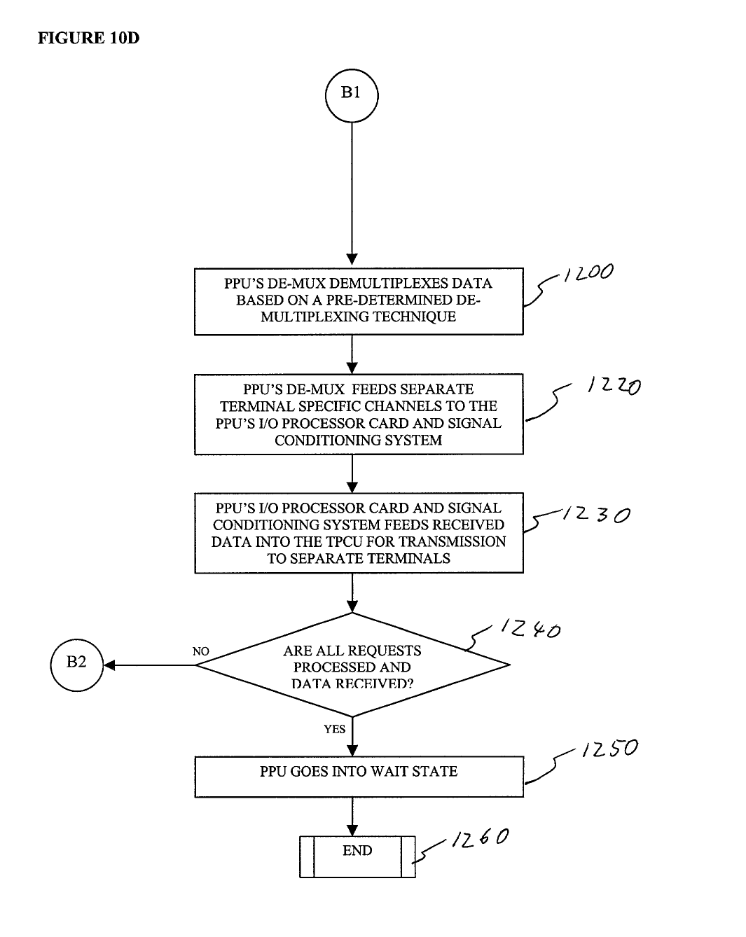

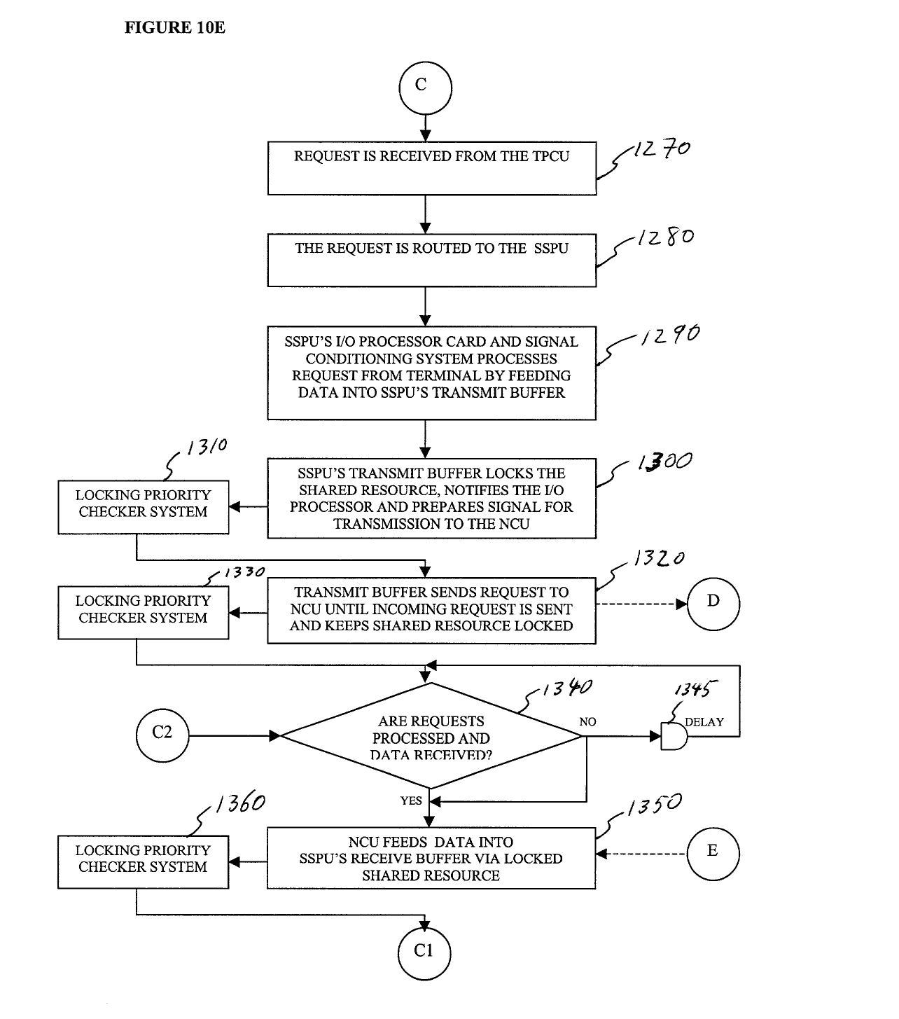

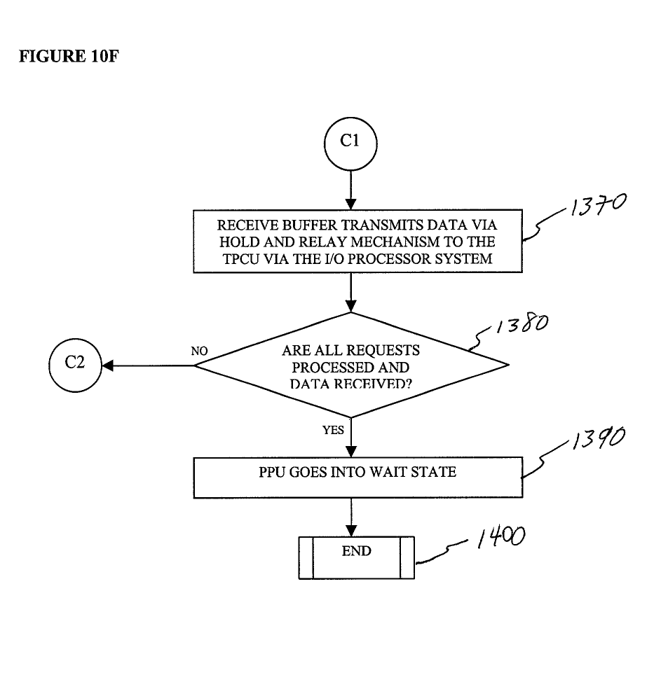

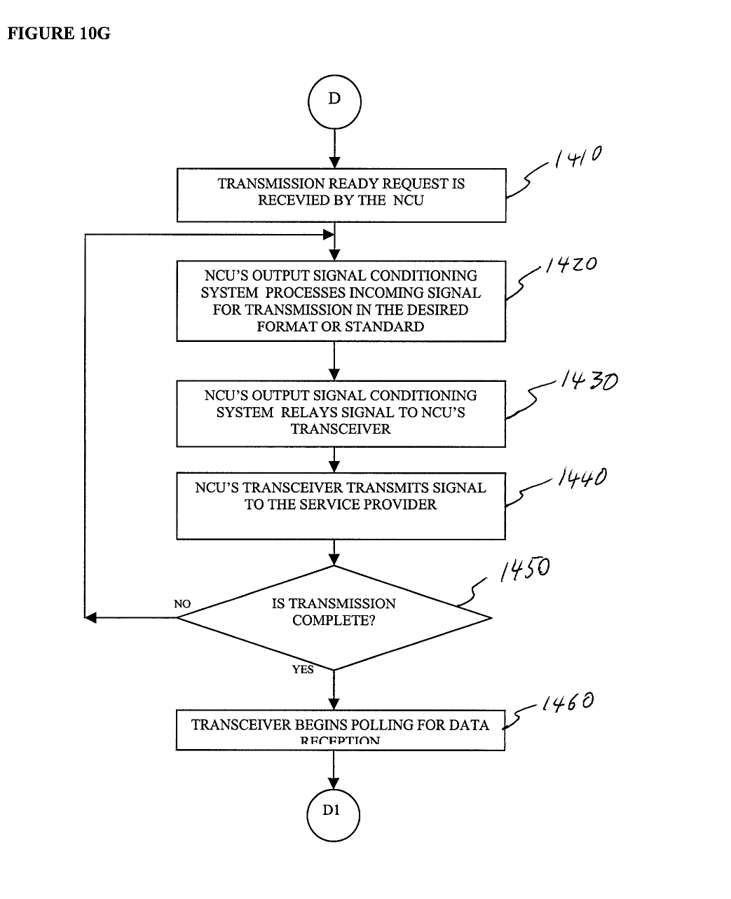

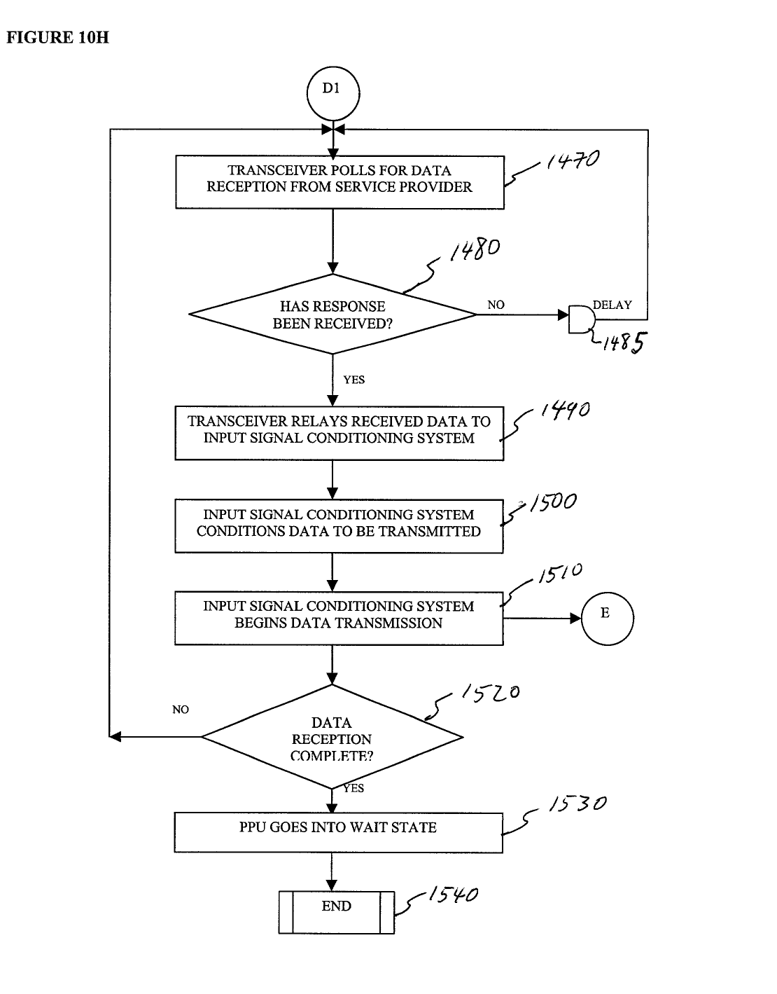

FIGS. 10A-10H show a flow chart of a process using a wireless network adapter. A process 1000 may begin 1010 when a terminal makes a request to communicate data, as shown in step 1020. The wireless network adapter (“WNA”) may receive the request at the terminal port cluster unit (“TPCU”), and convert the request into a format for use within the WNA, as shown in step 1030. As shown in step 1040, it may then be determined if the request is an intelligent services unit request. If the request is an intelligent services unit request, then the process 1000 may process may proceed to step 1090 of FIG. 10B. If the process is not an intelligent services unit request, then the process may proceed to step 1050 where it is determined if the request is a port processing unit request. If the request is a port processing unit request, then the process 1000 may proceed to step 1130 of FIG. 10C. If the request is not a port processing unit request, then the process 1000 may proceed to step 1060 where it is determined if the request is a shared signal processing unit request. If the request is a shared signal processing unit request, then the process 1000 may proceed to step 1270 of FIG. 10E. If the request is not a shared signal processing unit request, then the process 1000 may proceed to step 1070 where the terminal may be notified of an unprocessed request. It will further be appreciated that whatever type of request is made, the process 1000 may proceed to step 1070 where terminals may be notified of a request status. Processing of the request is then complete, and the process 1000 may end, as shown in step 1080.

As shown in FIG. 10B, where a request is an intelligent services unit request, as determined in step 1040, the process 1000 may proceed to step 1090 where the request may be routed to the intelligent services unit for processing. As shown in step 1100, the intelligent services unit may process system-specific requests using a system application processor. This may include, for example, checking the status of devices of connected to the wireless network adapter. As shown in step 1110, the intelligent services unit may process user-specific requests using a user application processor. This may include, for example, retrieving data, such as a v-card or contact information from a personal digital assistant and transferring it to a cellular phone. When processing of the intelligent services unit request is complete, the process 1000 may end, as shown in step 1120.

As shown in FIG. 10C, where a request is a port processing unit request, as determined in step 1050, the process 1000 may proceed to step 1130 where port processing unit request processing may begin with a non-local multi-service access request being received at the port processing unit from the terminal port cluster unit. As shown in step 1140, the request may be routed to the port processing unit. The port processing units input/output processor may multiplex the request with other requests from other terminals, as shown in step 1150. As shown in step 1160, the port processing unit may further process requests by combining terminal requests in a manner consistent with multiplexing techniques used by a network communications unit connected to the port processing unit. As shown in step 1170, the multiplexed signals including the request may be transmitted to the network communications unit. In step 1180, it is determined whether the requests have been processed and data received. If not, then the process 1000 delays, as shown in step 1185, and returns to step 1180 where the determination is repeated. If the requests have been process and data received, then the process 1000 proceeds to step 1190 where the network communications unit returns data to the port processing unit for demultiplexing, i.e., separation into data streams for devices connected to the wireless network adapter.

FIG. 10D shows further processing by the port processing unit. As shown in step 1200, the port processing unit may demultiplex data received from the network communications unit according to a predetermined technique. As shown in step 1220, the port processing unit may transmit data to the input/output processor of the port processing unit. As shown in step 1230, the input/output processor may transmit data to the terminal port cluster unit so that data may be communicated to devices attached to ports of the terminal port cluster unit. As shown in step 1240, it is determined whether all requests have been processed and data received. If not, then the process 1000 returns to step 1180 of FIG. 10C. If all of the requests have been processed and data received, then the process 1000 may proceed to step 1250 where the port processing unit goes into a wait state. The process 1000 may then end, as shown in step 1260.

As shown in FIG. 10E, where a request is a shared signal processing unit request as determined in step 1060, then shared signal processing unit processing begins with step 1270, where the shared resource request is received by the shared signal processing unit from the terminal port cluster unit. The request may be routed to the shared signal processing unit, as shown in step 1280. As shown in step 1290, the shared signal processing unit's input/output processor may transfer the data to the shared signal processing unit's transmit buffer. As shown in step 1300, the transmit buffer may lock the shared resource, e.g., a device providing data to the wireless network adapter, and prepares the data for transmission to the network communications unit. As shown in step 1310, priority of devices using the transmit buffer may be checked and priority of a current device may be locked by a locking priority checker system. The locking priority checker system may automatically assign priorities to one or more devices that are using the WNA, or the locking priority checker system may assign priorities according to user specifications, or the locking priority checker system may use some combination of these techniques. In general, the locking priority checker system operates to ensure that transfer of data through the shared signal processing unit is prioritized according to user-specified or system-supplied priorities.

As shown in step 1320, the transmit buffer may request access to the network communications unit, and may continue requesting access until the network communications unit acknowledges the request. The data may then be transmitted to the network communications unit. As shown in step 1330, the locking priority checker system may then release any priority locks for the device, or the locking priority checker system may create a lock on a receive buffer for reply data received from the network communications unit. As shown in step 1340, it is determined whether all requests have been processed and data received. If not, a delay is provided, as shown in step 1345, and then step 1340 may be repeated. If all requests have been processed and data received, then the network communications unit may feed data into the shared signal processing unit's receive buffer using locked resources within the receive buffer, as shown in step 1350. As shown in step 1360, the locking priority checker system may be accessed to release a lock on the receive buffer.

As shown in FIG. 10F, the process 1000 may continue in the shared signal processing unit. As shown in step 1370, the receive buffer may transmit data received from the network communications unit to the terminal port cluster unit through the input/output processor. As shown in step 1380, it may be determined whether all requests have been processed and data received. If not, then the process 1000 may return to step 1340 of FIG. 10E. If all requests have been processed and data received, then the port processing unit may go into a wait state as shown in step 1390. The process 1000 may then end, as shown in step 1400.

As shown in FIG. 10G, where a transmission ready request is transmitted to the network communications unit, the request is received by the network communications unit in step 1410. This may be, for example, when the port processing unit is ready to transmit, as in step 1170 of FIG. 10C, or when the shared signal processing unit is ready to transmit, as in step 1320 of FIG. 10E. As shown in step 1420, the network communications unit may convert data into a form suitable for transmission using a wireless standard such as CDMA, TDMA, Personal Communications Systems, Global System Mobile, Wireless Access Protocol, any Second or Third Generation mobile telephony standard, and so forth. As shown in step 1430, the network communications unit may forward the data to the wireless transceiver. As shown in step 1440, the data may then be transmitted to a service provider using the wireless network connection. As shown in step 1450, it may then be determined if the wireless transmission is complete. If not, the process 1000 may return to step 1420. If transmission is complete, then the process 1000 may proceed to step 1460 where the wireless transceiver begins polling for receipt of data from the service provider.

As shown in FIG. 10H, the process 1000 may continue in the network communications unit. In step 1470, the wireless transceiver may poll for data from the service provider. As shown in step 1480, it is determined whether a response has been received. If no response has been received, then a delay 1485 is provided and the process 1000 may return to step 1470. If a response has been received, then the process 1000 may proceed to step 1490 where the data may be forwarded to an input signal conditioning system. As shown in step 1500, the data may be conditioned to a form suitable to a device connected to the wireless network adapter. As shown in step 1510, the data may be transmitted to an associated device, through the terminal port cluster unit. As shown in step 1520, it is determined whether data reception is complete. If not, then the process 1000 may return to step 1470. If data reception is complete, then the port processing unit may go into a wait state, as shown in step 1530. As shown in step 1540, the process 1000 may then end.

It will be appreciated that many of the above steps may be realized in a variety of physical devices. The steps may be realized using a processor with suitable software, or with other programmable or dedicated devices including microcontrollers, digital signal processors, programmable digital signal processors, application specific integrated circuits, programmable gate arrays, programmable logic devices, programmable application logic, and so forth. Certain aspects may also be realized with discrete digital and/or analog components, as well as a combination of programmable devices and discrete components. Any of these components may be suitably employed with the invention, provided they possess sufficient processing speed to process data at a rate consistent with a system constructed according to the principles of the invention.

Using the systems and methods described above, a monitoring system may be realized. For example, a number of medical monitoring devices may be connected to the WNA. Modular device ports may be provided, as described above, so that each monitoring device may be connected to the WNA, which may then operate as a hub for communicating data between monitoring devices, as well as between a central processor and the distributed monitoring devices. The intelligent services unit may be used, for example, to provide centralized control of the monitoring devices, including, for example, turning devices on and off at predetermined times, generating alarms based upon data received from the monitoring devices, or providing charts and other materials to a printer for generation of reports.

Using the systems and methods described above, a high-speed wireless data link may be formed. The multiplexing/demultiplexing functions of the shared signal processing unit in a first wireless network adapter may be used, for example, to convert a high-speed data stream into a plurality of lower speed data streams. The lower speed data streams may be transmitted over a wireless connection to a second wireless network adapter, or to a wireless base station. At the second wireless network adapter or wireless base station, the multiple streams may be demultiplexed into a single, high-speed data stream.

While the invention has been disclosed in connection with the preferred embodiments shown and described in detail, various modifications and improvements thereon will be readily apparent to those skilled in the art.

1. An apparatus for aggregating device communications, the apparatus comprising:
a body;
a plurality of local ports, each local port configured to establish bi-directional data communications with a local device, and each local port using a different communication protocol;
a remote access port, the remote access port configured to establish bi-directional wireless data communications with a service provider; and
a processing system for converting data signals between a form adapted to one of the plurality of local ports and a form adapted to the remote access port.

2. The apparatus of claim 1, the processing system further comprising a port processing unit that converts data signals between a form adapted to more than one of the plurality of local ports into a form adapted to a multiple access air interface of the remote access port.

3. The apparatus of claim 1, the processing system further comprising a shared signal processing unit that converts data signals between a form adapted to more than one of the plurality of local ports into a form adapted to a single channel of the remote access port.

4. The apparatus of claim 1, wherein the body is shaped and sized to be worn by a person.

5. The apparatus of claim 1 wherein the plurality of local ports include at least one of a Bluetooth port, a HomeRF port, an IrDA port, a wireless Ethernet port, a wired serial port, a wired parallel port, or a wireless local area network port.

6. The apparatus of claim 1 wherein the remote access port includes a wireless port.

7. The apparatus of claim 6 wherein the wireless port includes at least one of a CDMA port, a TDM port, a GSM port, a PCS port, or a third generation cellular telephony port.

8. The apparatus of claim 1, the service provider connected in a communicating relationship with the remote access port through an air interface establishing bi-directional wireless data communications with the remote access port, and the service provider including an Internet connection, whereby a local device connected in a communicating relationship with one of the plurality of local ports may communicate through the Internet.

9. The apparatus of claim 1 further comprising a local device connecting in a communicating relationship with one of the plurality of local ports, the local device including at least one of a personal digital assistant, a notebook computer, a laptop computer, a cellular phone, a palm computer, or a wearable computer.

10. The apparatus of claim 9, the wearable computer including at least one of a wearable eyeglass computer or a wearable audio computer.

11. The apparatus of claim 1, the remote access port including a plurality of data channels, the bi-directional wireless data communications being distributed among two or more of the plurality of data channels.

12. The apparatus of claim 1 wherein the body is at least one of a portable accessory, a modular add-on device, or a base station accessory.

13. The apparatus of claim 1, the processing system further comprising one or more processors that convert traffic between data for more than one of the plurality of local ports and data for a logical channel of the remote access port.

14. The apparatus of claim 1, the processing system further comprising one or more processors that convert traffic between data for more than one of the plurality of local ports and data for a plurality of logical channels of the remote access ports.

15. The apparatus of claim 1 further comprising a services unit that provides network services to the plurality of local ports.

16. The apparatus of claim 15, the network services including at least one of device connectivity, error detection and correction, load balancing, caching, traffic management, congestion control, file sharing, printer sharing, and distributed computing.

17. The apparatus of claim 1 wherein the plurality of local ports comprise a terminal port cluster, the terminal port cluster including a plurality of connectors, each connector adapted to removably receive a modular device port, the modular device port adapted to a single communications technique.

18. A system for aggregating device communications, the apparatus comprising:
a body;
a plurality of local communications means for maintaining communications with one or more local devices;
a remote communications means for maintaining wireless communications means with a service provider; and
a converting means for converting data signals between a form adapted to the plurality of local communications means and the remote communications means.

19. A method for aggregating device communications, the method comprising:
receiving local data from a plurality of local devices;
converting the local data into converted local data, the converted local data having a form suitable for transmission over a wireless communication link;
transmitting the converted local data over the wireless communication link;
receiving network data from a service provider over the wireless communication link;
converting the network data into converted network data, the converted network data having a form suitable for transmission to one or more of the plurality of local devices; and
transmitting the converted network data to one or more of the plurality of local devices.

20. The method of claim 19 wherein converting the local data includes multiplexing the local data into a plurality of data streams corresponding to more than one channel of a multiple access wireless interface.

21. The method of claim 19 wherein converting the local data includes sequentially converting the local data from selected ones of the plurality of local devices.

22. The method of claim 19 wherein converting the local data includes prioritizing the plurality of local devices and converting data from a selected one of the plurality of local devices according to a priority of the selected one of the plurality of local devices.

23. An apparatus for aggregating device communications, the apparatus comprising:
a wearable body;
a plurality of local ports, each local port configured to establish bi-directional data communications with a local device, and each local port using a different communication protocol;
a remote access port, the remote access port configured to establish bi-directional wireless data communications with a service provider;
a processing system for converting data signals between a form adapted to one of the plurality of local ports and a form adapted to the remote access port; and
a services unit that provides network services to one or more local devices connected to the plurality of local ports.
